(19) United States
(12) Patent Application Publication
(10) Pub. No.: US 2025/0179239 A1
(43) Pub. Date: Jun. 5, 2025

(54) EPOXY RESIN CURED PRODUCT AND FABRICATING METHOD THEREOF

(71) Applicant: NATIONAL TSING HUA UNIVERSITY, Hsinchu (TW)

(72) Inventors: Ying-Ling LIU, Taichung City (TW); Du-Yuan HUNG, Changhua County (TW); Jia-Jun LEE, Kaohsiung City (TW)

(21) Appl. No.: 18/655,388

(22) Filed: May 6, 2024

(30) Foreign Application Priority Data
Nov. 28, 2023 (TW) 112146050

(51) Int. Cl. C08G 59/50; C08G 59/24; C08G 59/42

(52) U.S. Cl. CPC C08G 59/5033; C08G 59/245; C08G 59/4215

(57) ABSTRACT

An epoxy resin cured product and a fabricating method thereof are provided. The epoxy resin cured product has a dynamic bond and a non-dynamic bond, which is prepared with an epoxy resin hardener and an epoxy resin. The epoxy resin hardener includes both a primary amine group and a Meldrum's acid group.

### RELATED APPLICATION

This application claims priority to Taiwan Application Serial Number 112146050, filed Nov. 28, 2023, which is herein incorporated by reference.

### BACKGROUND

### Technical Field

The present disclosure relates to an epoxy resin cured product and a fabricating method thereof. More particularly, the present disclosure relates to an epoxy resin cured product containing a dynamic bond and a fabricating method thereof.

### Description of Related Art

The conventional epoxy resins are a class of thermosetting polymers, which cannot be recycled and reused after the processing and forming. Therefore, in the current technology, the dynamic bond is introduced into the cross-linked structure of the epoxy resin, so that the epoxy resin can form a recyclable/reprocessable vitrimer.

Currently, the technologies capable of achieving the abovementioned goal include: (1) use of an acid anhydride hardener to form the cross-linked structure of the dynamic ester bond, but this technology cannot be expanded to other types of hardeners; (2) use of a dynamic bond-containing hardener/epoxy resin monomer to form the epoxy resin polymer, but the dynamic bond-containing hardener used in this technology is unstable during the storage or the hardening reaction.

Therefore, how to make the epoxy resin cured product which contains the dynamic bond while still achieving the excellent thermal and mechanical properties, and can also solve the abovementioned problems, is the goal of the relevant industry.

### SUMMARY

According to one aspect of the present disclosure, an epoxy resin cured product is provided. The epoxy resin cured product has a dynamic bond and a non-dynamic bond and is prepared with an epoxy resin hardener and an epoxy resin. The epoxy resin hardener includes both a primary amine group and a Meldrum's acid group.

According to another aspect of the present disclosure, a method for fabricating an epoxy resin cured product includes the step of performing a curing reaction, wherein an epoxy resin hardener is reacted with an epoxy resin to obtain the epoxy resin cured product, and the epoxy resin cured product has a dynamic bond and a non-dynamic bond. The epoxy resin hardener includes both a primary amine group and a Meldrum's acid group.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a method for fabricating an epoxy resin cured product according to one embodiment of the present disclosure.

FIG. 2 is a Fourier-transform infrared spectroscopy (FTIR) spectrum of Example 1 and MA-Pae.

FIG. 3 is a FTIR spectrum of Example 1 and Comparative Example 1.

FIG. 4A is a scanning electron microscopy image of a cross-section of Example 1.

FIG. 4B is a scanning electron microscopy image of a cross-section of Example 2.

FIG. 5A is a DMA thermogram of Example 1 and Comparative Example 1.

FIG. 5B is a DMA thermogram of Example 1 to Example 4.

FIG. 6 is a DSC thermogram of Example 1 and Comparative Example 1.

FIG. 7A is a TGA thermogram of Example 1 and Comparative Example 1 under nitrogen.

FIG. 7B is a TGA thermogram of Example 1 to Example 4 under nitrogen.

FIG. 8A is a stress-strain diagram of Example 1 and Comparative Example 1.

FIG. 8B is a stress-strain diagram of Example 1 to Example 4.

FIG. 9A is a strain-time relationship diagram of Comparative Example 1.

FIG. 9B and FIG. 9C are the strain-time relationship diagrams of Example 1.

### DETAILED DESCRIPTION

The present disclosure will be further exemplified by the following specific embodiments. However, the embodiments can be applied to various inventive concepts and can be embodied in various specific ranges. The specific embodiments are only for the purposes of description and illustration, and the disclosed invention(s) are not limited to these practical details thereof.

In the present disclosure, the compound structure can be represented by a skeleton formula, and the representation can omit the carbon atom, the hydrogen atom and the carbon-hydrogen bond. In the case that the functional group is depicted clearly in the structural formula, the depicted one is preferred.

In the present disclosure, in order to concise and smooth, “epoxy resin hardener has a structure represented by formula (I)” can be represented as “an epoxy resin hardener represented by formula (I)” or “an epoxy resin hardener (I)” in some cases, and the other compounds or groups can be disclosed and represented in the same manner.

### Epoxy Resin Cured Product

In one embodiment, an epoxy resin cured product of the present disclosure is provided, which has a dynamic bond and a non-dynamic bond, and is prepared with an epoxy resin hardener and an epoxy resin. The epoxy resin hardener includes both a primary amine group and a Meldrum's acid group (MA). Moreover, a ratio of the non-dynamic bond to the dynamic bond ranges from 5:1 to 1:5, preferably from 3:1 to 1:3, and more preferably from 2:1 to 1:2.

Specifically, the epoxy resin hardener of the present disclosure has a structure represented by formula (I):

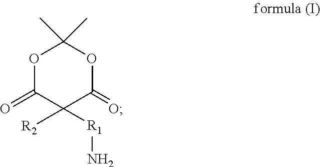

wherein R¹ can be an ether group, an ester group, an amine group or other heteroatom chains, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains. R² can be a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains.

The aforementioned “substituted” means that at least one hydrogen atom can be substituted by a monovalent group, and the monovalent group can be an alkyl group of 1 to 60 carbon atoms, an alkenyl group of 2 to 60 carbon atoms or an alkynyl group of 2 to 60 carbon atoms.

According to the aforementioned epoxy resin hardener (I), R¹ can be but is not limited to a structure represented by formula (i):

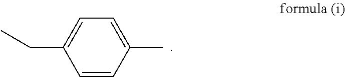

Specifically, in the formula (I), R¹ is the structure represented by the formula (i), and R² is a methyl group. The epoxy resin hardener has a structure represented by formula (I-1):

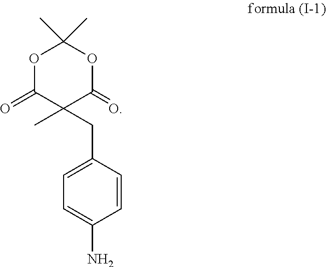 [SMILES: CC1(C)OC(=O)C(C)(Cc2ccc(N)cc2)C(=O)O1]

The aforementioned epoxy resin can be a common epoxy resin on the market, which can be but is not limited to a bisphenol A epoxy resin (BPA), a phenolic novolac epoxy resin (PNE), a cresol novolac epoxy resin (CNE), a dicyclopentadiene-phenol epoxy resin (DNE), a naphthalene-containing epoxy resin or a phosphorus based epoxy resin.

For example, the epoxy resin cured product of the present disclosure prepared with the bisphenol A epoxy resin and the epoxy resin hardener represented by the formula (I-1) as shown in Table 1.

TABLE 1

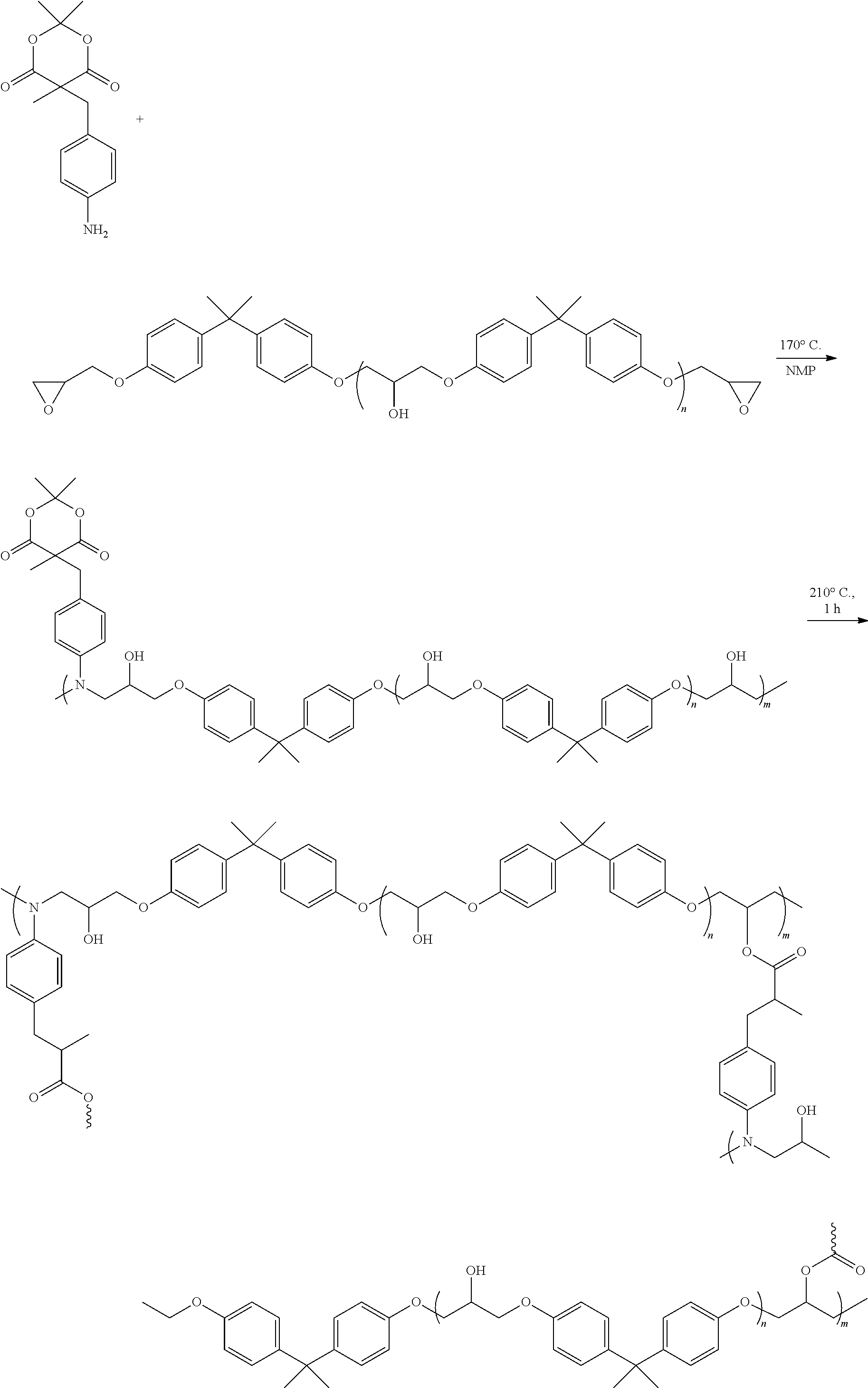

### Method for Fabricating Epoxy Resin Cured Product

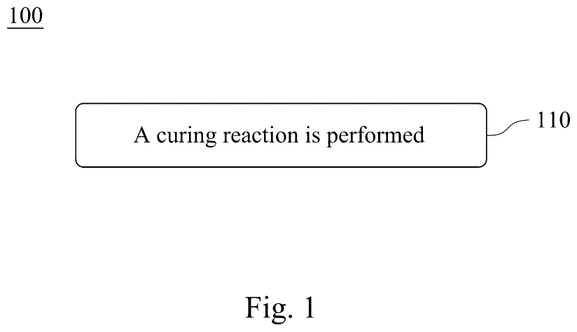

Reference is made to FIG. 1, which is a flow chart of a method for fabricating an epoxy resin cured product 100 according to one embodiment of the present disclosure. In FIG. 1, the method for fabricating the epoxy resin cured product 100 includes a step 110.

In the step 110, a curing reaction is performed, wherein an epoxy resin hardener is reacted with an epoxy resin to obtain the epoxy resin cured product, and the epoxy resin cured product has a dynamic bond and a non-dynamic bond. Moreover, an equivalent ratio of the epoxy resin to the epoxy resin hardener can range from 2:1 to 1:2, preferably from 1.5:1 to 1:1.5, and more preferably from 1.2:1 to 1:1.2. The definition of the epoxy resin hardener and the epoxy resin can be found in the aforementioned paragraph, and will not be described herein.

Specifically, the curing reaction between the epoxy resin hardener represented by the formula (I-1) and the epoxy resin mainly has two parts. The first part is the amine-epoxy addition reaction between the primary amine group in the epoxy resin hardener and the epoxy resin to form an amine-epoxy polymer containing the Meldrum's acid group. Further, the second part is the cross-linking reaction of the amine-epoxy polymer containing the Meldrum's acid group under heating, wherein the Meldrum's acid group is thermally decomposed to generate a ketene group, and the ketene group will be reacted with a hydroxyl group (—OH) in the epoxy resin to form the dynamic ester bond in the cross-linked network in the epoxy resin cured product. The reaction process of the Meldrum's acid group generates the dynamic ester bond as shown in Table 2.

TABLE 2

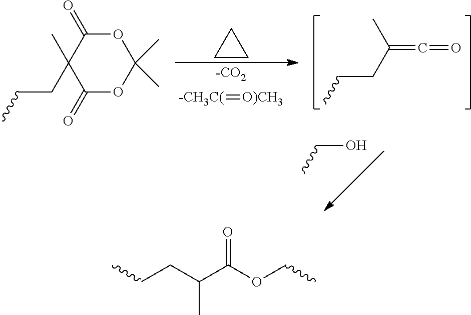

Therefore, the epoxy resin cured product of the present disclosure is obtained by reacting the epoxy resin hardener containing the primary amine group and the Meldrum's acid group with the epoxy resin, which combines the curing mechanism of the traditional epoxy resin with the in-situ formation of the dynamic bond, and uses a one-pot reaction to prepare the epoxy resin cured product with the permanent amine bond (non-dynamic bond) as well as the dynamic ester bond (dynamic bond) at the same time. It is the vitrimer based on the epoxy resin, which has the recyclable and reprocessable properties.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not meant to be limiting.

### Example/Comparative Example

In Example 1 of the present disclosure, the same equivalent of bisphenol A epoxy resin (epoxy equivalent is 188 e/q) and the epoxy resin hardener represented by the formula (I-1) (hereinafter referred to as MAMA) are dissolved in the dry N-methyl-2-pyrrolidone (NMP). Then, the abovementioned solution is reacted at 170° C. for 8 hours to form an intermediate product of the amine-epoxy polymer containing the Meldrum's acid group (hereinafter referred to as MA-Pae). Next, MA-Pae is poured into a mold and heated at 80° C. for 12 hours to remove the solvent, and then cured at 170° C., 190° C., and 210° C. for 1 hour at each temperature to obtain the epoxy resin cured product of Example 1.

In Example 2 of the present disclosure, the epoxy resin cured product of Example 1 is mechanically grinded into the particles, and the particles are thermally pressed at 220° C. and 14 MPa for 1 hour to obtain the first-time recycled epoxy resin cured product of Example 2. Moreover, both Example 3 and Example 4 are using the same method to obtain the second-time recycled and the third-time recycled epoxy resin cured product, respectively.

Furthermore, Comparative Example 1 is the epoxy resin cured product prepared by the same preparation method as Example 1, but the epoxy resin hardener of Comparative Example 1 is changed to 4,4′-diaminodiphenylmethane (DDM).

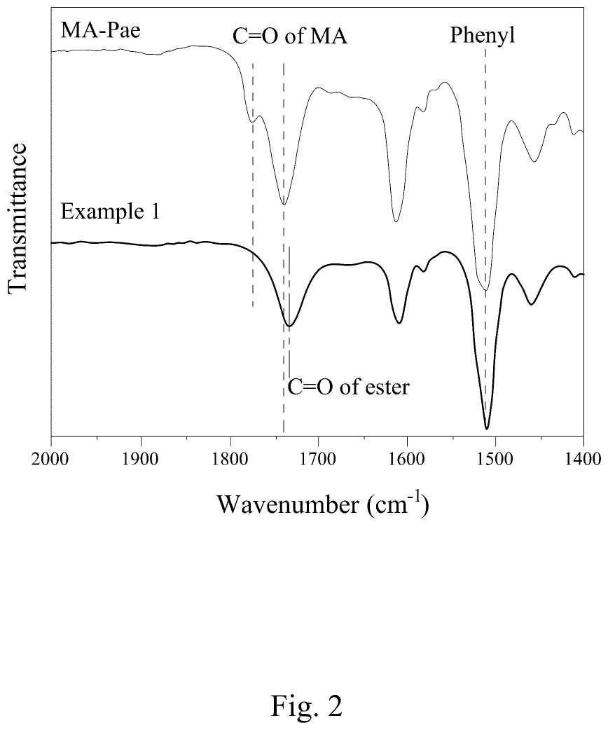

Reference is made to FIG. 2, which is a FTIR spectrum of Example 1 and MA-Pae. As shown in FIG. 2, the characteristic peaks of the Meldrum's acid group of MA-Pae are located at 1738 cm⁻¹ and 1775 cm⁻¹. However, the characteristic peak of the Meldrum's acid group of Example 1 disappeared, while the characteristic peak of C═O of the ester group appeared at 1733 cm⁻¹. These results indicate that the Meldrum's acid group of Example 1 will be converted into the ester group after the addition reaction of ketene/—OH.

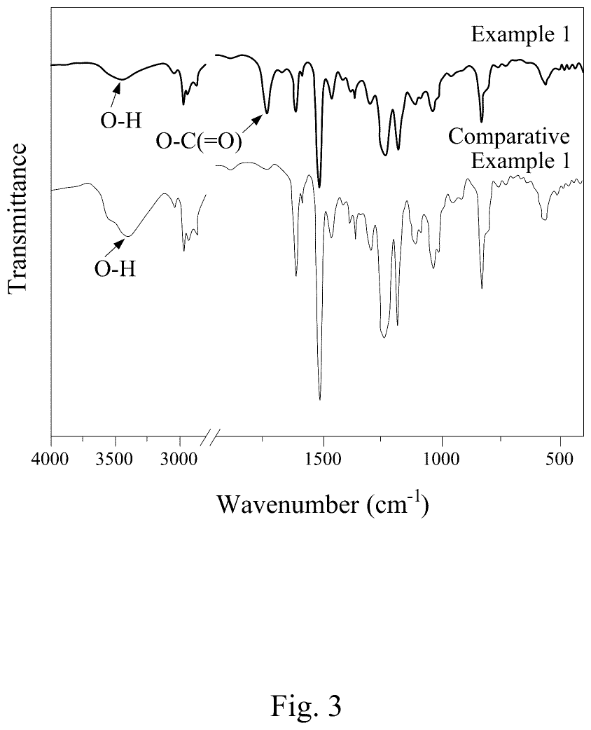

Reference is made to FIG. 3, which is a FTIR spectrum of Example 1 and Comparative Example 1. As shown in FIG. 3, compared with Comparative Example 1, the obvious characteristic peak of the ester group of Example 1 appeared at 1731 cm⁻¹, and the relatively weak characteristic peak of the —OH group appeared at 3390 cm⁻¹. These results indicate that the formation of the ester group by the addition reaction of ketene/—OH during the curing reaction in Example 1.

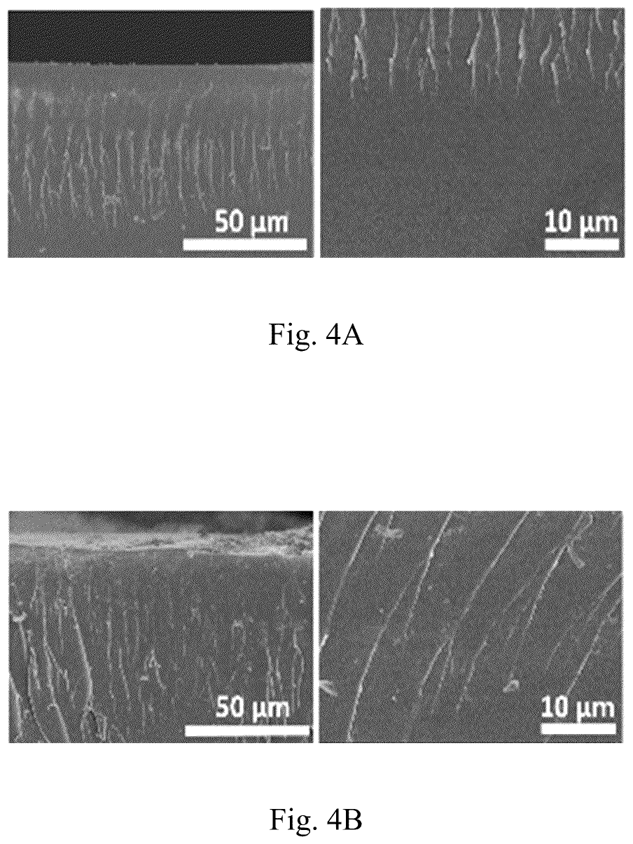

Reference is made to FIG. 4A and FIG. 4B, wherein FIG. 4A is a scanning electron microscopy image of a cross-section of Example 1, and FIG. 4B is a scanning electron microscopy image of a cross-section of Example 2. As shown in FIG. 4A and FIG. 4B, both the epoxy resin cured product of Example 1 and the reprocessed and recycled product of Example 2 have a dense and defect-free morphology. It is shown that the chains and the networks of Example 1 are debonded and fused well in the molecular levels, indicating that Example 1 has the heat recyclable property and reprocessable property.

### Thermal Property Analysis

Example 1 to Example 4 and Comparative Example 1 are performed the thermal property evaluation. The thermal property analysis methods include dynamic mechanical analysis (DMA), differential scanning calorimetry (DSC) and thermo-gravimetric analysis (TGA).

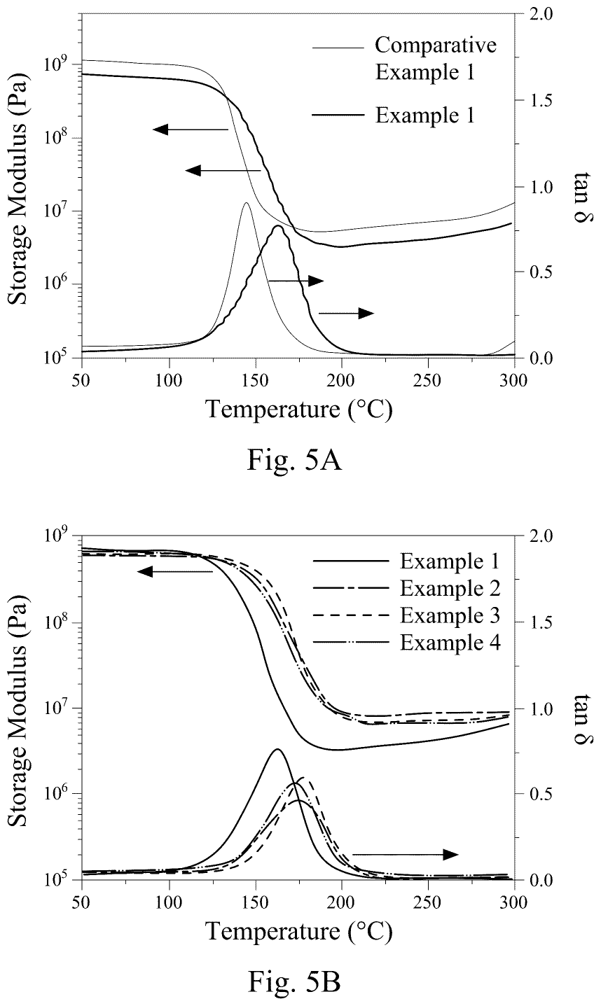

Reference is made to FIG. 5A and FIG. 5B, wherein FIG. 5A is a DMA thermogram of Example 1 and Comparative Example 1, and FIG. 5B is a DMA thermogram of Example 1 to Example 4. The storage modulus, the glass transition temperature (T_{g}) and the crosslinking density of Example 1 to Example 4 and Comparative Example 1 can be measured by the DMA analysis, and the measurement results are shown in Table 3.

TABLE 3

| | Storage | T_{g} | Crosslinking |
|---|---|---|---|
| | modulus | (° C.) | density |
| | (MPa) | (DMA) | (mmole/cm³) |
| Example 1 | 720 | 164 | 1.8 |
| Example 2 | 603 | 175 | 3.1 |
| Example 3 | 624 | 178 | 2.9 |
| Example 4 | 667 | 174 | 2.9 |
| Comparative | 1135 | 145 | 2.4 |
| Example 1 | | | |

As shown in the abovementioned results, the glass transition temperatures of Example 1 to Example 4 are higher than that of Comparative Example 1. Although the crosslinking density of Example 1 is lower than that of Comparative Example 1, this is attributed to the relatively rigid ester bond in the network of Example 1. Furthermore, the crosslinking densities of Example 2 to Example 4 are higher than that of Example 1, which is due to the trace amount of the Meldrum's acid group remained in Example 1, and the additional crosslinking sites that are formed after the reaction involving the Meldrum's acid group. The glass transition temperatures of Example 2 to Example 4, which are repeatedly recycled and reprocessed, do not change much during the heat treatment.

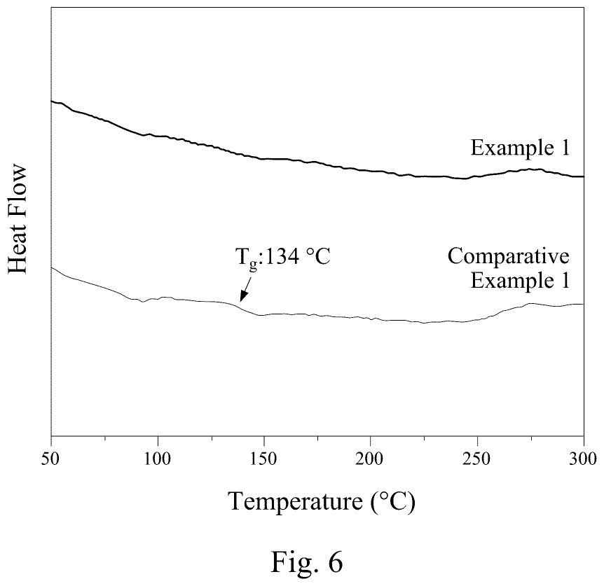

Reference is made to FIG. 6, which is a DSC thermogram of Example 1 and Comparative Example 1. The glass transition temperature (T_{g}) of Example 1 and Comparative Example 1 can be measured by the DSC analysis, and the measurement results are shown in Table 4.

TABLE 4

| | Example 1 | Comparative Example 1 |
|---|---|---|
| T_{g} (° C.) | — | 134 |

As shown in the abovementioned results, Example 1 does not show the exothermic behavior below 250° C., indicating that the amine/epoxy addition reaction and the ketene/—OH addition reaction of Example 1 have a high conversion rate. Moreover, the baseline shift at 134° C. is observed in Comparative Example 1, which is the glass transition temperature of Comparative Example 1. However, no obvious baseline shift is observed in Example 1.

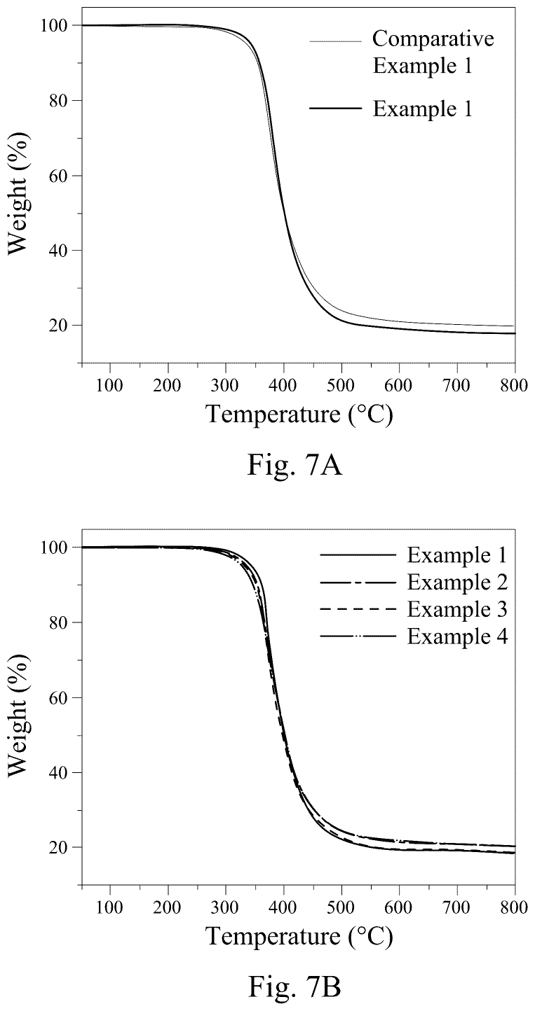

Reference is made to FIG. 7A and FIG. 7B, wherein FIG. 7A is a TGA thermogram of Example 1 and Comparative Example 1 under nitrogen, and FIG. 7B is a TGA thermogram of Example 1 to Example 4 under nitrogen. The 5% thermogravimetric loss temperature (T_{d5%}) and the Char yield of 800° C. under nitrogen of Example 1 to Example 4 and Comparative Example 1 can be measured by the TGA analysis, and the measurement results are shown in Table 5.

TABLE 5

| | T_{d5%} (° C.) | Char yield (%) |
|---|---|---|
| Example 1 | 345 | 18.5 |
| Example 2 | 336 | 20.3 |
| Example 3 | 335 | 18.9 |
| Example 4 | 330 | 20.4 |
| Comparative Example 1 | 336 | 20.3 |

As shown in the abovementioned results, Example 1 to Example 4 and Comparative Example 1 all show the similar and comparable stability under nitrogen. The 5% thermogravimetric loss temperature of Example 1 is the highest, which indicates that its thermal stability is the best.

### Mechanical Property Analysis

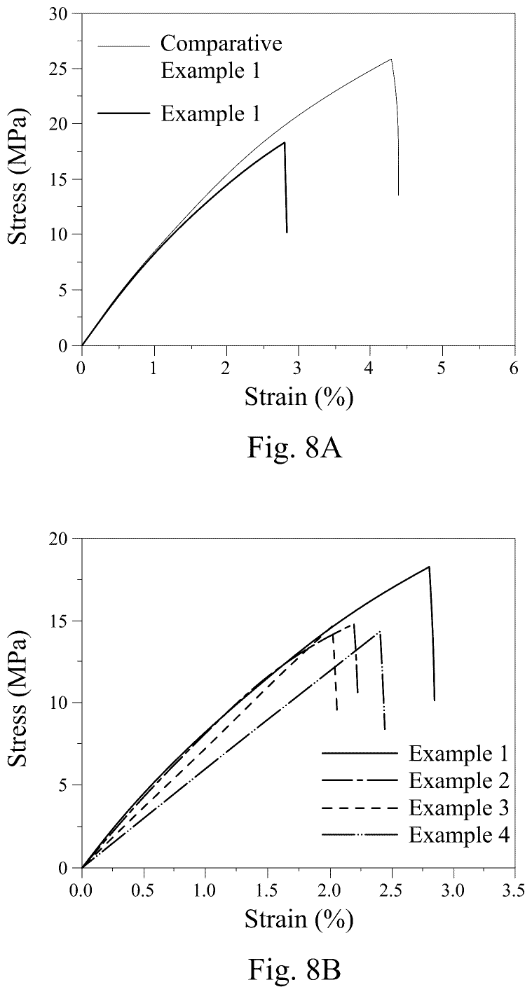

Example 1 to Example 4 and Comparative Example 1 are performed the mechanical property evaluation. Reference is made to FIG. 8A and FIG. 8B, wherein FIG. 8A is a stress-strain diagram of Example 1 and Comparative Example 1, and FIG. 8B is a stress-strain diagram of Example 1 to Example 4. The tensile strength, the elongation at break and the Young's modulus of Example 1 to Example 4 and Comparative Example 1 can be measured by the tensile test, and the measurement results are shown in Table 6.

TABLE 6

| | Tensile | Elongation | Young's |
|---|---|---|---|
| | strength | at break | modulus |
| | (MPa) | (%) | (MPa) |
| Example 1 | 18.3 | 2.8 | 910 |
| Example 2 | 15.0 | 2.1 | 860 |
| Example 3 | 14.8 | 2.2 | 880 |
| Example 4 | 14.8 | 2.0 | 770 |
| Comparative | 26.0 | 4.3 | 890 |
| Example 1 | | | |

As shown in the abovementioned results, Example 1 to Example 4 all show the comparable mechanical properties, and the tensile strength and the elongation at break of Example 1 are both slightly lower than those of Comparative Example 1, which is attributed to Example 1 having the rigid ester bond and the lower hydrogen bond density (fewer —OH groups).

Therefore, as shown in the thermal property analysis and the mechanical property analysis, compared with the commonly available epoxy resin cured products on the market, the epoxy resin cured product of Example 1 of the present disclosure has the comparable thermal and mechanical properties, so that Example 1 has the application potential as the substitute for commercial epoxy resin cured product. Furthermore, Example 1 can be repeatedly heat recovered and reprocessed without changing its thermal and mechanical properties.

### Creep Relaxation Test

Example 1 and Comparative Example 1 are performed the elongation creep test at different temperatures. In this test, the stress (1 MPa) is applied for 40 minutes, followed by releasing of the stress to examine the dynamic and vitrimer properties of Example 1.

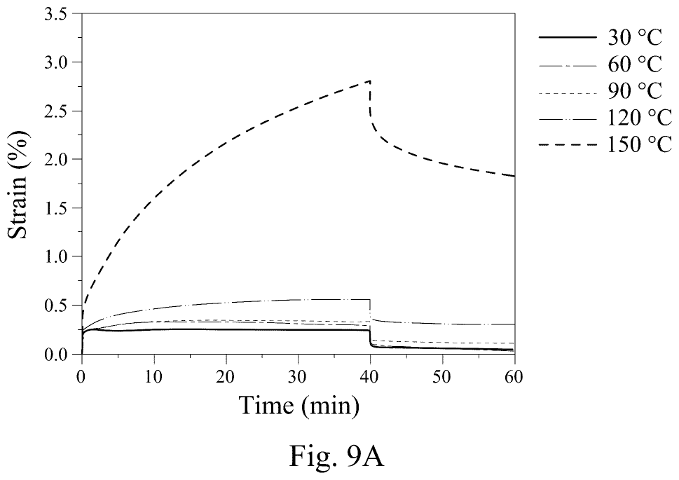

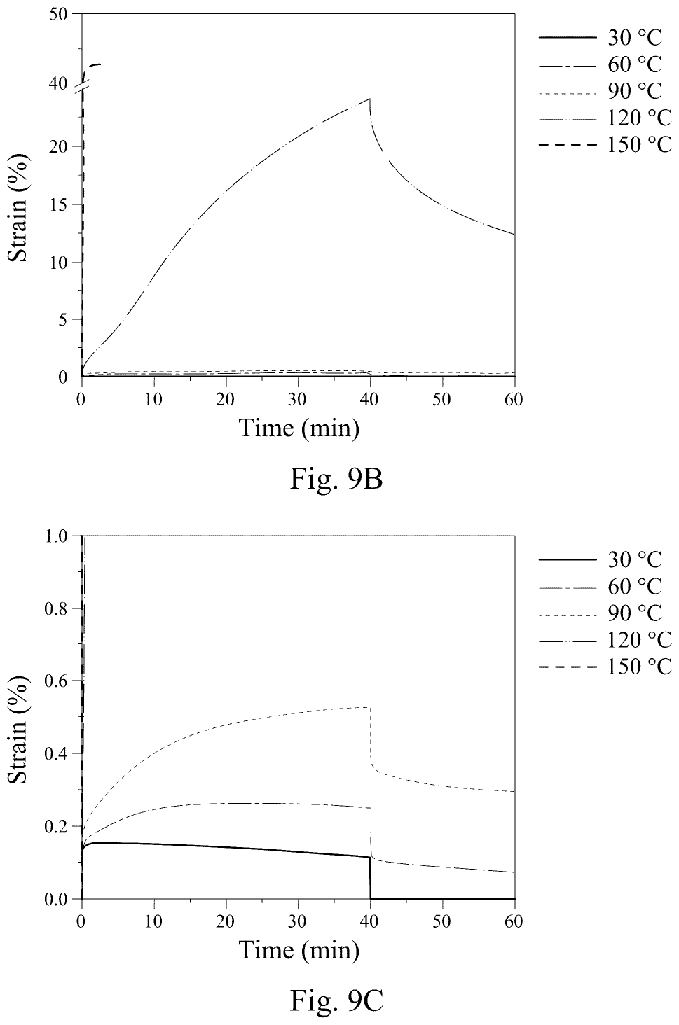

Reference is made to FIG. 9A, FIG. 9B and FIG. 9C. FIG. 9A is a strain-time relationship diagram of Comparative Example 1. FIG. 9B and FIG. 9C are the strain-time relationship diagrams of Example 1, wherein FIG. 9B shows the region of higher strain, and FIG. 9C shows the region of lower strain. As shown in FIG. 9A to FIG. 90, when the temperature is lower than 100° C., both Example 1 and Comparative Example 1 exhibit a relatively lower creep relaxation and a certain strain recovery elastic response. Nevertheless, Comparative Example 1 still shows the elastic-like behavior at 120° C., while Example 1 shows the higher elongation creep of about 25% at 120° C., and the strain recovery elastic response drops to about 48%. Furthermore, according to FIG. 5A, the storage modulus of Example 1 decreases rapidly and the increase in tanδ occurs at about 120° C., indicating that the chain mobility of Example 1 is increased at 120° C. These results of Example 1 indicate the presence of chain mobility in the crosslinked network from the creep relaxation test results, which can be attributed to the bond exchange through the transesterification reaction.

In conclusion, the epoxy resin cured product of the present disclosure utilizes a compound containing the primary amine group and the Meldrum's acid group as the hardener for curing of the epoxy resin. The non-dynamic bond of the permanent amine bond and the dynamic bond of the dynamic ester bond can be generated in-situ in the crosslinked network of the epoxy resin by the amine/epoxy addition reaction and the ketene/—OH addition reaction. Therefore the epoxy resin cured product after curing has the recyclable and reprocessable properties, and the thermal and the mechanical properties thereof are comparable to those of the epoxy resin cured product cured by the traditional hardener, and it has the potential to replace the traditional epoxy resin cured product.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An epoxy resin cured product, having a dynamic bond and a non-dynamic bond, and prepared with an epoxy resin hardener and an epoxy resin;
wherein the epoxy resin hardener comprises both a primary amine group and a Meldrum's acid group.

2. The epoxy resin cured product of claim 1, wherein the dynamic bond is an ester bond.

3. The epoxy resin cured product of claim 1, wherein the epoxy resin is a bisphenol A epoxy resin, a phenolic novolac epoxy resin, a cresol novolac epoxy resin, a dicyclopentadiene-phenol epoxy resin, a naphthalene-containing epoxy resin or a phosphorus based epoxy resin.

4. The epoxy resin cured product of claim 1, wherein the epoxy resin hardener has a structure represented by formula (I): 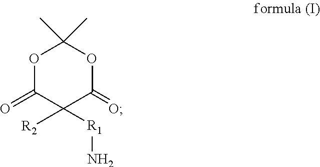
wherein R¹ is an ether group, an ester group, an amine group or other heteroatom chains, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains;
wherein R² is a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains.

5. The epoxy resin cured product of claim 4, wherein in the formula (I), R¹ is a structure represented by formula (i):

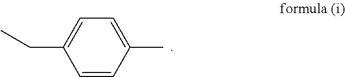

6. The epoxy resin cured product of claim 1, wherein a ratio of the non-dynamic bond to the dynamic bond ranges from 5:1 to 1:5.

7. A method for fabricating an epoxy resin cured product, comprising:
performing a curing reaction, wherein an epoxy resin hardener is reacted with an epoxy resin to obtain the epoxy resin cured product, and the epoxy resin cured product has a dynamic bond and a non-dynamic bond;
wherein the epoxy resin hardener comprises both a primary amine group and a Meldrum's acid group.

8. The method for fabricating the epoxy resin cured product of claim 7, wherein the primary amine group is reacted with the epoxy resin to form the non-dynamic bond.

9. The method for fabricating the epoxy resin cured product of claim 7, wherein the Meldrum's acid group is thermally decomposed during the curing reaction to generate a ketene group.

10. The method for fabricating the epoxy resin cured product of claim 9, wherein the ketene group is reacted with a hydroxyl group in the epoxy resin to form the dynamic bond.

11. The method for fabricating the epoxy resin cured product of claim 10, wherein the dynamic bond is an ester bond.

12. The method for fabricating the epoxy resin cured product of claim 7, wherein the epoxy resin is a bisphenol A epoxy resin, a phenolic novolac epoxy resin, a cresol novolac epoxy resin, a dicyclopentadiene-phenol epoxy resin, a naphthalene-containing epoxy resin or a phosphorus based epoxy resin.

13. The method for fabricating the epoxy resin cured product of claim 7, wherein the epoxy resin hardener has a structure represented by formula (I): 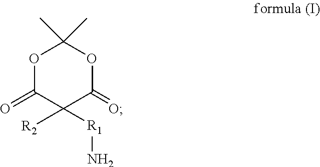
wherein R¹ is an ether group, an ester group, an amine group or other heteroatom chains, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains;
wherein R² is a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted aryl group of 6 to 30 carbon atoms or other carbon chains.

14. The method for fabricating the epoxy resin cured product of claim 13, wherein in the formula (I), R¹ is a structure represented by formula (i):

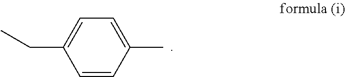

15. The method for fabricating the epoxy resin cured product of claim 7, wherein an equivalent ratio of the epoxy resin to the epoxy resin hardener ranges from 2:1 to 1:2.
